(19) United States
(12) Patent Application Publication
(10) Pub. No.: US 2018/0137047 A1
(43) Pub. Date: May 17, 2018

(54) BACKUP METHOD FOR THE MAPPING TABLE OF A SOLID STATE DISK

(71) Applicant: QUANTA STORAGE INC., Taoyuan CIty (TW)

(72) Inventors: An-Te LIU, Taoyuan City (TW); Chun-Hung HUNG, Taoyuan City (TW); Jin-Shing HSIEH, Taoyuan City (TW)

(21) Appl. No.: 15/693,575

(22) Filed: Sep. 1, 2017

(30) Foreign Application Priority Data
Nov. 15, 2016 (CN) 201611028067.1

(51) Int. Cl. G06F 12/02; G06F 3/06

(52) U.S. Cl. CPC G06F 12/0246; G06F 3/0688; G06F 2212/7201; G06F 3/061; G06F 3/0655

(57) ABSTRACT

A backup method for the mapping table of a solid state disk is provided. When access of a user data and writing of backup data units are processed at the same time, by adjusting a data volume of each of the backup data units and a length of a time lag interval, the data volume of the backup data units to be processed is reduced. More capacity will be available for processing access of the user data. Thus, the access efficiency of the user data is maintained.

This application claims the benefit of People's Republic of China application Serial No. 201611028067.1, filed Nov. 15, 2016, the subject matter of which is incorporated herein by reference.

### BACKGROUND OF THE INVENTION

### Field of the Invention

The invention relates in general to a solid state disk (SSD), and more particularly to a backup method of an SSD for writing a logical to physical (L2P) mapping table temporarily stored in a buffer memory to a flash memory.

### Description of the Related Art

Solid state drive (SSD) integrates negative-AND (NAND) flash memory arrays into a single storage device. Since the flash memory is subject to erase times, data needs to be distributed to the flash memory arrays of the SSD, and a logical to physical (L2P) mapping table is established to manage a mapping relationship between the logical address of the data and the physical address of the data stored in the flash memory to facilitate the access of the data of the SSD.

Refer to FIG. 7. In order to manage the relationship between the logical address of the data and the physical address in which the data is actually stored in the flash memory array 1, when the SSD of the prior art is activated, the management data of each data block of the flash memory array 1 is read to form an L2P mapping table between the logical address and the physical address of the data, and then the L2P mapping table is stored in a buffer memory 2. The buffer memory 2 is a volatile random access memory, and the memory data stored in the buffer memory 2 will disappear when the power is interrupted. Therefore, the L2P mapping table needs to be backed up to the nonvolatile flash memory array 1, such that when the power is resumed, the backup data of the L2P mapping table can be read from the flash memory array 1 and the L2P mapping table can be quickly established in the buffer memory 2.

When the SSD of the prior art backs up an L2P mapping table, the L2P mapping table is usually written to the flash memory array 1 to be backed up during the time slots between the access of the user data to avoid the access efficiency of the user data of the buffer memory 2 being affected. When backing up the L2P mapping table, a host often instructs the SSD to access the user data. If the backup data of the L2P mapping table does not have a large volume, the SSD can respond to the instructions of the host instantaneously without significantly affecting the access efficiency of the user data. If the backup data of the L2P mapping table has a large volume, the SSD needs a longer time to write the backup data and will be unable to respond to the instructions of the host instantaneously. The access efficiency of the user data will be greatly affected. To the worse, the access efficiency may even drop to zero, and the user may need to wait for a longer time or may keep waiting.

According to another prior art, when accessing the user data, the SSD at the same time writes the backup data of the L2P mapping table to the flash memory array 1. Although both the access efficiency of the user data and the backup efficiency of the L2P mapping table will be affected and reduced, the access efficiency of the user data still maintains at a certain level and is prevented from dropping to zero. Thus, the user will not feel waiting around or feel that the access efficiency of the user data is too low.

However, according to the prior art as illustrated in FIG. 8, when the user data is accessed and the backup data of the L2P mapping table is at the same time written to the flash memory array 1, each segment of the curve P indicating the access efficiency of the user data is significantly lowered by the lower shadow lines p. It causes the deviation of the access efficiency of the user data, and the access efficiency of the user data cannot maintain at the same level. Therefore, the SSD still has many problems to tackle with when it comes to the backup method for the mapping table.

### SUMMARY OF THE INVENTION

According to one aspect of the present invention, a backup method for a mapping table of a solid state disk is provided. According to the backup method, the backup data of the L2P mapping table is divided into a plurality of backup data units, which are transmitted according to a plurality of time lag intervals, processed at the same time with the access of the user data, and written to a flash memory, such that the access efficiency of the user data is increased.

According to another aspect of the present invention, a backup method for the mapping table of a solid state disk is provided. According to the backup method, the data volume of the backup data units and the length of the time lag intervals are adjusted to assure that the access efficiency of the user data is higher than a threshold and the access efficiency of the user data is maintained.

To achieve the objects of the present invention, a backup method for the mapping table of a solid state disk is provided. An L2P mapping table is dynamically maintained at the volatile buffer memory of the SSD. The L2P mapping table backup is divided into a plurality of backup data units according to a default data volume. The backup data units are separated according to a plurality of default time lag intervals. Access of a user data and writing of the backup data units to a flash memory of the SSD are processing at the same time. During the time lag interval, only the user data is accessed, such that the access efficiency of the user data is increased.

According to one embodiment of the present invention, a backup method for the mapping table of a solid state disk is provided. If it is determined that the access efficiency of the user data is not higher than a threshold, the data volume or the time lag interval of the backup data units stored in the buffer memory but not transmitted is adjusted, and the backup data units are transmitted for subsequent processing. If it is determined that the access efficiency of the user data is higher than the threshold, then the backing up of the L2P mapping table is completed.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a functional block diagram of an electronic device storage system of the present invention.

FIG. 2 is a schematic diagram of backing up a mapping table of an SSD according to the present invention.

FIG. 3 is a curve diagram of the access efficiency of the user data according to the present invention.

FIG. 4 a flowchart of a backup method for the mapping table of a solid state disk according to the present invention.

FIG. 5 is a schematic diagram of backing up a mapping table of an SSD according to another embodiment of the present invention.

FIG. 6 a flowchart of a backup method for the mapping table of a solid state disk according to another embodiment of the present invention.

FIG. 7 is a schematic diagram of backing up a mapping table of an SSD according to the prior art.

FIG. 8 is a schematic diagram of backing up a mapping table of an SSD according to the prior art.

### DETAILED DESCRIPTION OF THE INVENTION

The technical methods adopted to achieve the above objects of the present invention and the consequent effects are disclosed in a number of preferred embodiments below with reference to the accompanying drawings.

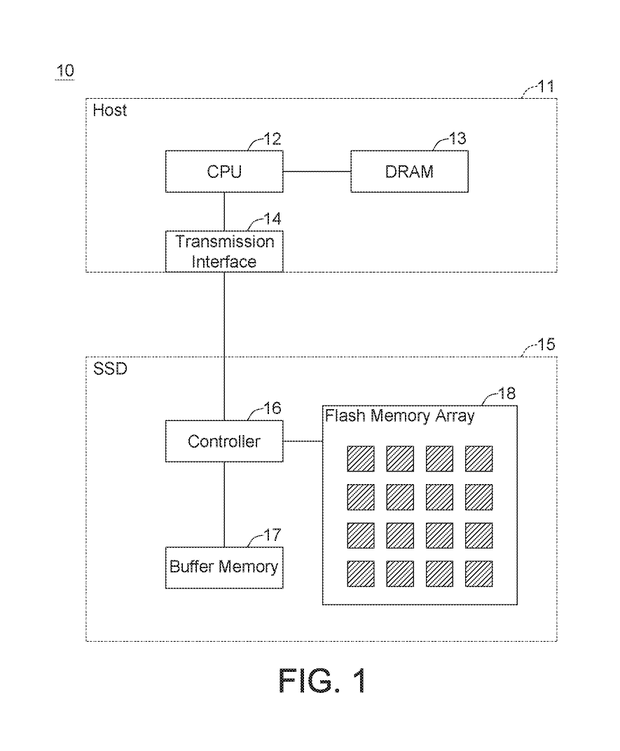

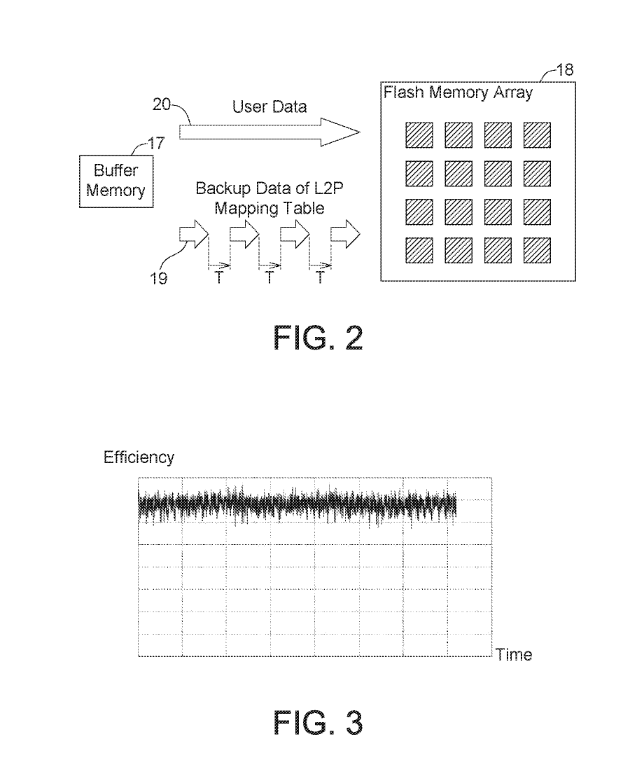

Refer to FIG. 1 to FIG. 3. FIG. 1 is a functional block diagram of an electronic device storage system of the present invention. FIG. 2 is a is schematic diagram of backing up a mapping table of an SSD according to the present invention. FIG. 3 is a curve diagram of the access efficiency of the user data according to the present invention. As illustrated in FIG. 1, the electronic device storage system 10 of the present invention includes a host 11 and a solid state drive (SSD) 15, wherein the host 11 includes a central processing unit (CPU) 12, a dynamic random access memory (DRAM) 13, and a transmission interface 14, and the SSD 15 includes a controller 16, a buffer memory 17, and a flash memory array 18. The CPU 12, in corporation with the DRAM 13, sends an instruction for accessing the logical address of a user data to the SSD 15 connected to the transmission interface 14. The controller 16, in corporation with the buffer memory 17, receives the instruction for accessing the logical address of the user data from the host 11, accesses data from the physical address of the flash memory array 18 corresponding to the logical address, stores the accessed data to the buffer memory 17, and transmits the accessed data to the DRAM 13 of the host 11 for the host 11 to back up.

In order to manage the relationship between the logical address of the data and the physical address in which the data is actually stored in the flash memory array 18, when the SSD 15 is actuated, the management data of each data block of the flash memory array 18 is read to form an L2P mapping table between the logical address and the physical address of the data, and then the L2P mapping table is stored in the buffer memory 17. In addition, in order to avoid the memory data of the L2P mapping table stored in the volatile buffer memory 17 disappearing when the power is interrupted, the L2P mapping table is periodically backed up to the nonvolatile flash memory array 18, such that when the power is resumed, the backup data of the L2P mapping table can be read from the flash memory array 18 and the L2P mapping table can be quickly established in the buffer memory 17.

Refer to FIG. 2. Because the controller 16 of the SSD 15 is restricted by the efficiency of the machine, the data volume that the controller 16 can process per unit time is subjected to an upper limit. To maintain the access efficiency of the user data at a certain level and avoid the backup data of the L2P mapping table being over-processed and the access efficiency of the user data being affected, the backup data of the L2P mapping table is firstly divided into a plurality of backup data units 19 according to a default data volume when the L2P mapping table of the buffer memory 17 is backed up to the flash memory array 18. Then, the controller 16 processes the access of the user data 20 and the backing up of the L2P mapping table at the same time, wherein the user data 20 processed at the same time maintains a certain data volume, and the backup data units 19 of the L2P mapping table processed at the same time are separated according to a number of default time lag intervals T. When the controller 16 processes the access of the user data 20 and the writing of the backup data units 19 at the same time, both the access efficiency of the user data and the backup efficiency of the L2P mapping table will be affected and drop down. Since the backup data units 19 have a smaller data volume, the access of the user data 20 is affected for a shorter time. The controller 16 only needs to process the access of the user data 20 during the time lag intervals T, and the access efficiency of the user data 20 can be significantly increased.

The access efficiency of the user data 20 is evaluated according to the unit time. In the present invention, the backup data of the L2P mapping table is divided into a plurality of backup data units 19, then separated according to a number of default time lag intervals T and written to a flash memory array, such that the backup data of the L2P mapping table can be processed in a decentralized manner, and the unit time for processing the backup data of the L2P mapping table is reduced. Moreover, the time lag intervals T can also be used to avoid the processing time of access of the user data 20 being crowded out, such that more user data 20 can be accessed per unit time and the access efficiency of the user data 20 can be increased. As illustrated in FIG. 3, in the present invention, the backing up of the L2P mapping table at intervals and the access of the user data are processed at the same time, such that the lower shadow lines for each segment of curve showing the access efficiency of the user data is very small and has minor impact on the access efficiency of the user data. Therefore, the deviation in the access efficiency of the user data is reduced, and the access efficiency of the user data can maintain at the same level.

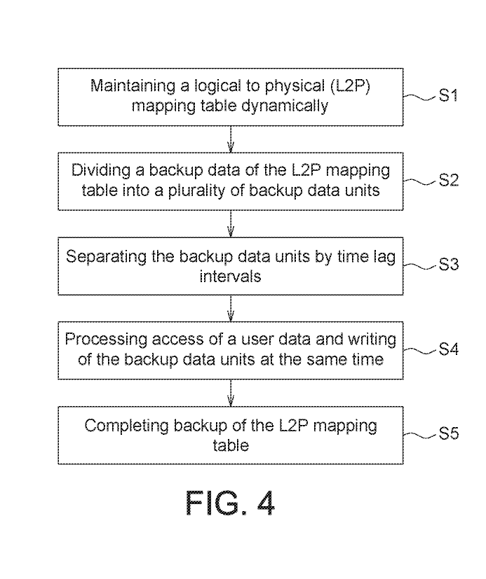

Referring to FIG. 4, a flowchart of a backup method for the mapping table of a solid state disk according to the present invention is shown. The backup method for the mapping table of the solid state disk according to the present invention includes the following steps. Firstly, the method begins at step S1, an L2P mapping table is dynamically maintained in a buffer memory. In step S2, a backup data of the L2P mapping table is divided into a plurality of backup data units. In step S3, the backup data units are separated by time lag intervals. In step S4, access of a user data and writing the backup data units to a flash memory array are processed at the same time. Lastly, the method proceeds to step S5, periodical backup of the L2P mapping table is completed in a flash memory array.

According to the backup method for the mapping table of a solid state disk of the present invention, the backup data of the L2P mapping table is divided into a plurality of backup data units, which are separated according to time lag intervals, transmitted from the buffer memory, and written to the flash memory array at the same time when the user data is accessed, such that the processing efficiency of the user data is less affected, and the access efficiency of the user data is increased.

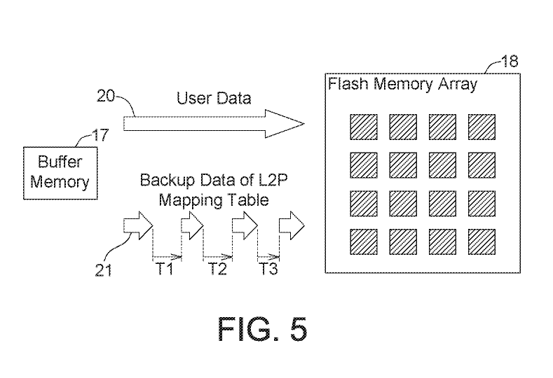

Referring to FIG. 5, a schematic diagram of backing up a mapping table of an SSD according to another embodiment of the present invention is shown. The present embodiment is different from previous embodiment mainly in that the access efficiency of the user data is changed by adjusting the data volume of the backup data units and the length of the time lag intervals. To avoid repetition, designations common to the present and previous embodiments are used to indicate identical or similar elements. According to the backup method for the mapping table of a solid state disk of the present embodiment, when the L2P mapping table of the buffer memory 17 is backed up to the flash memory array 18, the backup data of the L2P mapping table is firstly divided into a plurality of backup data units 21 with adjustable data volume. Then, the backup data units 21 are separated according to the time lag intervals T1˜T3 with adjustable lengths, and transmitted to the controller to be processed at the same time with the accessed user data 20. When it is determined that the access efficiency of the user data drops and is not higher than a default threshold, the backup method of the present embodiment can be used to maintain the access efficiency of the user data at a certain level by reducing the data volume of the backup data units 21 or increasing the length of the time lag intervals. When the data volume of the backup data units 21 is reduced, the controller will use less capacity to process the data volume of the backup data units 21 but will use more capacity to process the access of the user data 20. According to the present embodiment, when the length of the time lag intervals is increased, the controller will have more time to process the access of the user data 20, and the access efficiency of the user data 20 will be increased accordingly.

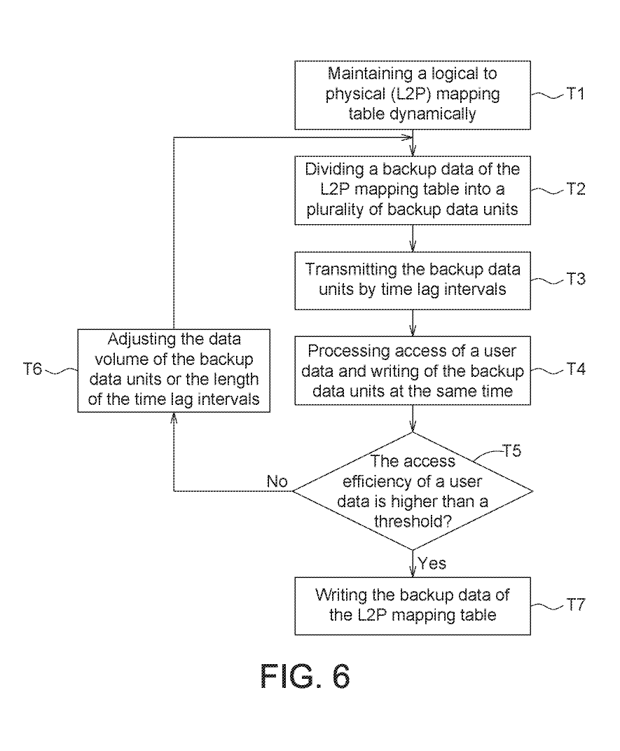

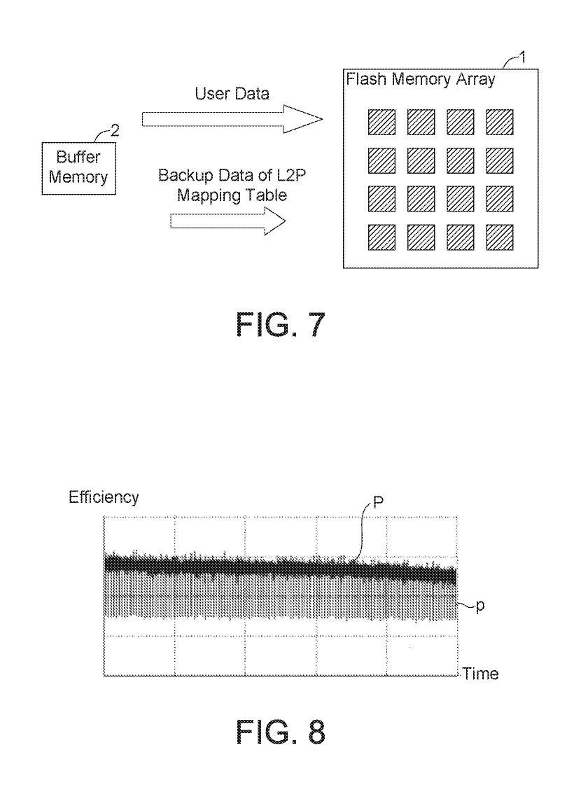

Referring to FIG. 6, a flowchart of a backup method for the mapping table of a solid state disk according to another embodiment of the present invention is shown. The backup method for the mapping table of the solid state disk according to the present embodiment includes the following steps. The method begins at step T1, an L2P mapping table is dynamically maintained in a buffer memory. In step T2, the backup data of the L2P mapping table is divided into a plurality of backup data units. In step T3, the backup data units are separated by time lag intervals. In step T4, the user data is accessed and at the same time the backup data units are written to the flash memory array. In step T5, whether the access efficiency of a user data is higher than a default threshold is determined. If the access efficiency of the user data is not higher than the threshold, then the method proceeds to step T6, and the data volume of the backup data units which are not yet transmitted or the length of the time lag intervals is adjusted, and the method returns to step T2 to continue processing. If the access efficiency of the user data is higher than the threshold, then the method proceeds to step T7, and the backing up of the L2P mapping table is completed.

According to the backup method for the mapping table of a solid state disk of the present invention, by adjusting the data volume of the backup data units and the length of the time lag intervals, the controller processes a smaller data volume of the backup data units and will have more capacity to process the access of the user data, such that the access efficiency of the user data can be maintained above the default threshold and the goal to maintain the access efficiency of the user data can be achieved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A backup method for a mapping table of a solid state disk (SSD), comprising:
maintaining a logical to physical (L2P) mapping table dynamically;
dividing a backup data of the L2P mapping table into a plurality of backup data units;
separating the backup data units according to a plurality of time lag intervals; and
processing access of a user data and writing of the backup data units at the same time.

2. The backup method for the mapping table of the solid state disk according to claim 1, wherein the L2P mapping table is maintained in a volatile buffer memory of the SSD.

3. The backup method for the mapping table of the solid state disk according to claim 1, wherein the backup data units are written into a flash memory array of the SSD.

4. The backup method for the mapping table of the solid state disk according to claim 1, wherein each of the backup data units has a default data volume.

5. The backup method for the mapping table of the solid state disk according to claim 1, wherein each of the time lag intervals is a default time lag.

6. The backup method for the mapping table of the solid state disk according to claim 1, wherein during each of the time lag interval, only the access of the user data is processed.

7. A backup method for a mapping table of a solid state disk (SSD), comprising:
maintaining a logical to physical (L2P) mapping table dynamically;
dividing a backup data of the L2P mapping table into a plurality of backup data units;
separating the backup data units according to a plurality of time lag intervals;
processing access of a user data and writing of the backup data units is at the same time;
adjusting the backup data units which are not transmitted in a buffer memory of the SSD when an access efficiency of the processed user data is determined to be not higher than a threshold and transmitting the backup data units for subsequent processing.

8. The backup method for the mapping table of the solid state disk according to claim 7, wherein a data volume of each of the backup data units which are not yet transmitted is adjusted.

9. The backup method for the mapping table of the solid state disk according to claim 7, wherein a time lag interval of the backup data units which are not yet transmitted is adjusted.

10. The backup method for the mapping table of the solid state disk according to claim 7, wherein if it is determined that an access efficiency of the user data is higher than a threshold, then backing up of the L2P mapping table is completed.
